(19) United States
(12) Patent Application Publication
(10) Pub. No.: US 2014/0254402 A1
(43) Pub. Date: Sep. 11, 2014

(54) Method and/or System for Determining Time of Arrival of Data Packets

(71) Applicant: QUALCOMM INCORPORATED, San Diego, CA (US)

(72) Inventor: Carlos Horacio Aldana, Mountain View, CA (US)

(73) Assignee: QUALCOMM INCORPORATED, San Diego, CA (US)

(21) Appl. No.: 13/791,834

(22) Filed: Mar. 8, 2013

(51) Int. Cl. H04W 24/02

(52) U.S. Cl. CPC H04W 24/02
USPC 370/252

(57) ABSTRACT

Disclosed are systems, methods and devices for application of estimating a apposition of a mobile device based, at least in part, on measuring differences of times of arrival of data packets transmitted to the mobile device from transmitters. In specific implementations, time-staggered quasi-matched filter correlators may applying a known waveform or data sequence to a payload of a received data packet to detect a correlation peak or correlation maximum corresponding to a time of arrival of the received data packet.

### BRIEF DESCRIPTION

1. Field

Embodiments described herein are directed to mobile navigation techniques.

2. Information

GPS and other like satellite positioning systems have enabled navigation services for mobile handsets in outdoor environments. Since satellite signals may not be reliably received and/or acquired in an indoor environment, different techniques may be employed to enable navigation services. For example, mobile devices may typically obtain a position fix by measuring ranges to three or more terrestrial wireless access points which may positioned at known locations. Such ranges may be measured, for example, by obtaining a MAC ID address from signals received from such access points and measuring one or more characteristics of signals received from such access points such as, for example, received signal strength indicator (RSSI), round trip delay (RTT), just to name a few examples.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a system diagram illustrating certain features of a system containing a mobile device, in accordance with an implementation.

FIG. 2 is a flow diagram illustrating a process for measuring a time of arrival of a packet received at a receiver according to an embodiment.

FIG. 3 is a schematic diagram of a receiver including multiple time staggered correlators according to an embodiment.

FIGS. 4 and 5 show fields in packets for wireless transmission according to alternative embodiments.

FIG. 6 is a schematic block diagram illustrating an exemplary device, in accordance with an implementation.

FIG. 7 is a schematic block diagram of an example computing platform in accordance with an implementation.

### SUMMARY

Briefly, particular implementations are directed to a method comprising, at a mobile device: wirelessly receiving one or more packets from a transmitter transmitted according to an IEEE std. 802.11 waveform, a payload of at least one of said received packets comprising a known waveform or data sequence; and applying said known waveform or data sequence at time-staggered quasi-matched filter correlators to said payload to detect a correlation peak; and estimating a time of arrival of said packet based, at least in part, on said correlation peak and a time reference.

Another particular implementation is directed to a mobile device comprising: a receiver to receive one or more signals from a wireless network; a plurality of time-staggered quasi-matched filter correlators configurable to convolve at least a portion of one or more packets received at said receiver and transmitted according to an IEEE std. 802.11 waveform, a payload of at least one of said received packets comprising a known waveform or data sequence; and one or more processors to: determine a correlation peak output signal among said time-staggered correlators; and estimate a time of arrival of said packet based, at least in part, on said correlation peak and a time reference.

Another particular implementation is directed to an article comprising: a non-transitory storage medium comprising machine-readable instructions stored thereon which are executable by a special purpose computing apparatus to: obtain a payload portion of one or more packets wirelessly received from a transmitter transmitted according to an IEEE std. 802.11 waveform, the payload comprising a known waveform or data sequence; apply said known waveform or data sequence at time-staggered quasi-matched filter correlators to said payload to detect a correlation peak; and estimate a time of arrival of said packet based, at least in part, on said correlation peak and a time reference.

Another particular implementation is directed to an apparatus comprising: means for wirelessly receiving one or more packets from a transmitter transmitted according to an IEEE 802.11 waveform, a payload of at least one of said received packets comprising a known waveform or data sequence; means for applying said known waveform or data sequence at time-staggered quasi-matched filter correlators to said payload to detect a correlation peak; and means for estimating a time of arrival of said packet based, at least in part, on said correlation peak and a time reference.

It should be understood that the aforementioned implementations are merely example implementations, and that claimed subject matter is not necessarily limited to any particular aspect of these example implementations.

### DETAILED DESCRIPTION

As pointed out above, a mobile device may apply any one of several techniques for obtaining a position fix based, at least in part, on measurements obtained from acquisition of signals while in an indoor environment. In one particular approach a mobile device may estimate its location based, at least in part, on measuring an observed time-difference-of-arrival (OTDOA) of synchronized signals transmitted by three or more transmitters positioned at known locations. In one example, these transmitters positioned at known locations may transmit packets formatted according to one or more versions of IEEE std. 802.11. Here, transmitters may be synchronized to a common clock and the packets are time-stamped according to the common clock. Using well known techniques, a mobile device may compute time differences of arrival of packets from the transmitters referenced to the common clock.

However, the length of a typical packet with a data payload transmitted according to IEEE std. 802.11 may impact a precision in a measurement of a time of arrival of a packet. Low precision measurements of the time of arrival may impact the precision and uncertainty of a position fix computed based upon times of arrival using techniques discussed above (e.g., OTDOA). In one particular implementation, according to an embodiment, a portion of a packet (e.g., packet formed in accordance with IEEE Std. 802.11) may be changed in particular situations to include a known waveform or data sequence instead of a data payload. The known waveform or data sequence may comprise replications of a known data field, constant amplitude zero autocorrelation sequences or a pseudonoise code as used to modulate signals in a CDMA data channel or GPS signal. Here, correlating the payload portion with the known waveform or data sequence using a matched filter on multiple time-staggered correlators at a receiver may provide a correlation peak at one of the correlators, which may be referenced to a more precise time of arrival of the packet at a receiver. Such a more precise time of arrival measurement for multiple packets may enable a more precise or accurate estimate of a location of the receiver using the aforementioned OTDOA technique, for example.

In another implementation, the aforementioned time-staggered matched filters may be implemented as more power efficient quasi-matched filters. As discussed below, in one particular example implementation, a quasi-matched filter may be implemented by applying a quantizer function to a known waveform or data sequence. Convolving a received signal with a quantized waveform or data sequence may entail fewer mathematical operations to implement and consume less energy than convolving the received with a non-quantized waveform or data sequence without sacrificing accuracy in detecting a time of arrival for a transmitted packet (e.g., for use in computing a location estimate based, at least in part, on OTDOA).

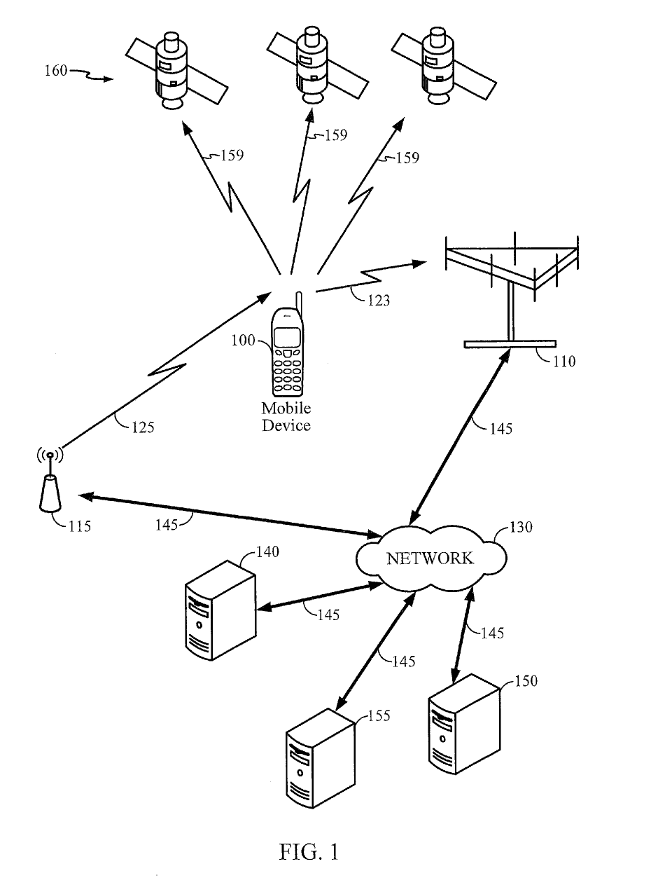

In certain implementations, as shown in FIG. 1, a mobile device 100 may receive or acquire satellite positioning system (SPS) signals 159 from SPS satellites 160. In some embodiments, SPS satellites 160 may be from one global navigation satellite system (GNSS), such as the GPS or Galileo satellite systems. In other embodiments, the SPS Satellites may be from multiple GNSS such as, but not limited to, GPS, Galileo, Glonass, or Beidou (Compass) satellite systems. In other embodiments, SPS satellites may be from any one several regional navigation satellite systems (RNSS′) such as, for example, Wide Area Augmentation System (WAAS), European Geostationary Navigation Overlay Service (EGNOS), Quasi-Zenith Satellite System (QZSS), just to name a few examples.

In addition, mobile device 100 may transmit radio signals to, and receive radio signals from, a wireless communication network. In one example, mobile device 100 may communicate with a cellular communication network by transmitting wireless signals to, or receiving wireless signals from, base station transceiver 110 over wireless communication link 123. Similarly, mobile device 100 may transmit wireless signals to, or receive wireless signals from local transceiver 115 over wireless communication link 125.

In a particular implementation, local transceiver 115 may be configured to communicate with mobile device 100 at a shorter range over wireless communication link 125 than at a range enabled by base station transceiver 110 over wireless communication link 123. For example, local transceiver 115 may be positioned in an indoor environment. Local transceiver 115 may provide access to a wireless local area network (WLAN, e.g., IEEE Std. 802.11 network) or wireless personal area network (WPAN, e.g., Bluetooth network). In another example implementation, local transceiver 115 may comprise a femto cell transceiver capable of facilitating communication on link 125 according to a cellular communication protocol. Of course it should be understood that these are merely examples of networks that may communicate with a mobile device over a wireless link, and claimed subject matter is not limited in this respect.

In a particular implementation, base station transceiver 110 and local transceiver 115 may communicate with servers 140, 150 and/or 155 over a network 130 through links 145. Here, network 130 may comprise any combination of wired or wireless links. In a particular implementation, network 130 may comprise Internet Protocol (IP) infrastructure capable of facilitating communication between mobile device 100 and servers 140, 150 or 155 through local transceiver 115 or base station transceiver 110. In another implementation, network 130 may comprise cellular communication network infrastructure such as, for example, abase station controller or master switching center (not shown) to facilitate mobile cellular communication with mobile device 100.

In particular implementations, and as discussed below, mobile device 100 may have circuitry and processing resources capable of computing a position fix or estimated location of mobile device 100. For example, mobile device 100 may compute a position fix based, at least in part, on pseudorange measurements to four or more SPS satellites 160. Here, mobile device 100 may compute such pseudorange measurements based, at least in part, on pseudonoise code phase detections in signals 159 acquired from four or more SPS satellites 160. In particular implementations, mobile device 100 may receive from server 140, 150 or 155 positioning assistance data to aid in the acquisition of signals 159 transmitted by SPS satellites 160 including, for example, almanac, ephemeris data, Doppler search windows, just to name a few examples.

In other implementations, mobile device 100 may obtain a position fix by processing signals received from terrestrial transmitters fixed at known locations (e.g., such as base station transceiver 110) using any one of several techniques such as, for example, advanced forward trilateration (AFLT) and/or OTDOA. In these particular techniques, a range from mobile device 100 may be measured to three or more of such terrestrial transmitters fixed at known locations based, at least in part, on pilot signals transmitted by the transmitters fixed at known locations and received at mobile device 100. Here, servers 140, 150 or 155 may be capable of providing positioning assistance data to mobile device 100 including, for example, locations and identities of terrestrial transmitters to facilitate positioning techniques such as AFLT and OTDOA. For example, servers 140, 150 or 155 may include a base station almanac (BSA) which indicates locations and identities of cellular base stations in a particular region or regions.

In particular environments such as indoor environments or urban canyons, mobile device 100 may not be capable of acquiring signals 159 from a sufficient number of SPS satellites 160 or perform AFLT or OTDOA to compute a position fix from acquisition of signals from outdoor terrestrial transmitters. Alternatively, mobile device 100 may be capable of computing a position fix based, at least in part, on signals acquired from local transmitters (e.g., WLAN access points, femto cell transceivers, Bluetooth devices, etc., positioned at known locations). For example, mobile devices may obtain a position fix by measuring ranges to three or more indoor terrestrial wireless access points which are positioned at known locations. Such ranges may be measured, for example, by obtaining a MAC ID address from signals received from such access points and obtaining range measurements to the access points by measuring one or more characteristics of signals received from such access points such as, for example, received signal strength (RSSI) or round trip time (RTT).

In another particular implementation, if indoor transmitters are synchronized, mobile device 100 may compute an estimate of its location based, at least in part, on an OTDOA. Here, three or more indoor transmitters (e.g., any combination of three or more local transceivers including WiFi transceivers, femto cells, Bluetooth transceivers, etc.). As pointed out above, a portion of received packets may include a known data sequence or waveform that may be convolved in multiple time-staggered correlators to provide an accurate measurement of time of arrival of received packets.

In particular implementations, mobile device 100 may receive positioning assistance data for indoor positioning operations from servers 140, 150 or 155. For example, such positioning assistance data may include locations and identities of transmitters positioned at known locations to enable measuring ranges to these transmitters based, at least in part, on a measured RSSI and/or RTT, for example. Other positioning assistance data to aid indoor positioning operations may include radio locations and identities of transmitters, routeability graphs, just to name a few examples. Other assistance data received by the mobile device may include, for example, local maps of indoor areas for display or to aid in navigation. Such a map may be provided to mobile device 100 as mobile device 100 enters a particular indoor area. Such a map may show indoor features such as doors, hallways, entry ways, walls, etc., points of interest such as bathrooms, pay phones, room names, stores, etc. By obtaining and displaying such a map, a mobile device may overlay a current location of the mobile device (and user) over the displayed map to provide the user with additional context.

In one implementation, a routeability graph and/or digital map may assist mobile device 100 in defining feasible areas for navigation within an indoor area and subject to physical obstructions (e.g., walls) and passage ways (e.g., doorways in walls). Here, by defining feasible areas for navigation, mobile device 100 may apply constraints to aid in the application of filtering measurements for estimating locations and/or motion trajectories according to a motion model (e.g., according to a particle filter and/or Kalman filter). In addition to measurements obtained from the acquisition of signals from local transmitters, according to a particular embodiment, mobile device 100 may further apply a motion model to measurements or inferences obtained from inertial sensors (e.g., accelerometers, gyroscopes, magnetometers, etc.) and/or environment sensors (e.g., temperature sensors, microphones, barometric pressure sensors, ambient light sensors, camera imager, etc.) in estimating a location or motion state of mobile device 100.

According to an embodiment, mobile device 100 may access indoor navigation assistance data through servers 140, 150 or 155 by, for example, requesting the indoor assistance data through selection of a universal resource locator (URL). In particular implementations, servers 140, 150 or 155 may be capable of providing indoor navigation assistance data to cover many different indoor areas including, for example, floors of buildings, wings of hospitals, terminals at an airport, portions of a university campus, areas of a large shopping mall, just to name a few examples. Also, memory resources at mobile device 100 and data transmission resources may make receipt of indoor navigation assistance data for all areas served by servers 140, 150 or 155 impractical or infeasible, a request for indoor navigation assistance data from mobile device 100 may indicate a rough or course estimate of a location of mobile device 100. Mobile device 100 may then be provided indoor navigation assistance data covering areas including and/or proximate to the rough or course estimate of the location of mobile device 100.

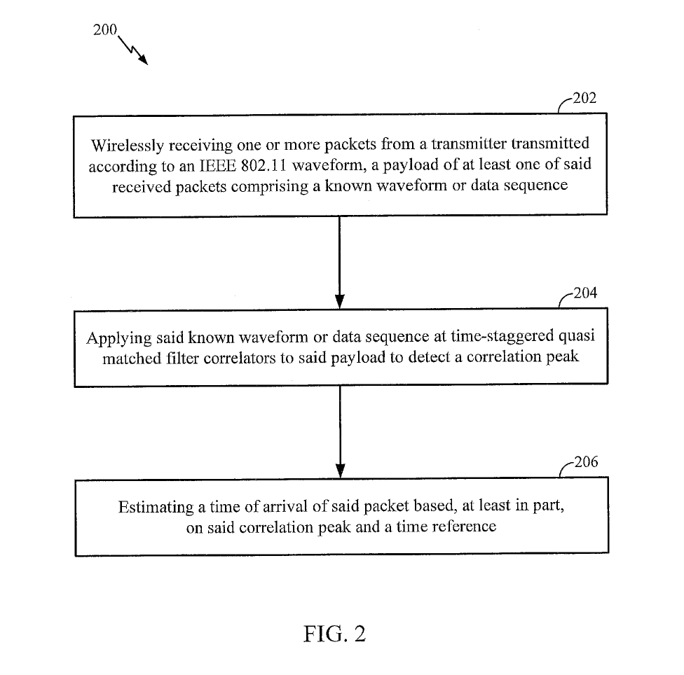

FIG. 2 is a flow diagram of a process 200 to be performed at a mobile device (e.g., mobile device 100) in a particular implementation. As discussed above, process 200 may be performed as part of a process to estimate a location of the mobile device based, at least in part, on an OTDOA measurement of data packets received from three or more transmitters. Block 202 may wirelessly receive one or more packets from a transmitter which are transmitted according to an IEEE std. 802.11 waveform. Such a transmitter may comprise a local access point positioned at a fixed and known location (e.g., a local transceiver 115). The received one or more packets may also include a payload comprising a known waveform or data sequence such as, for example, replications of a data field or symbol (e.g. replications of an L-STF or L-LTF data field of an IEEE std. 802.11 data packet), constant amplitude zero autocorrelation sequences or a pseudonoise code as used to modulate signals in a CDMA data channel or GPS signal, just to provide a few examples.

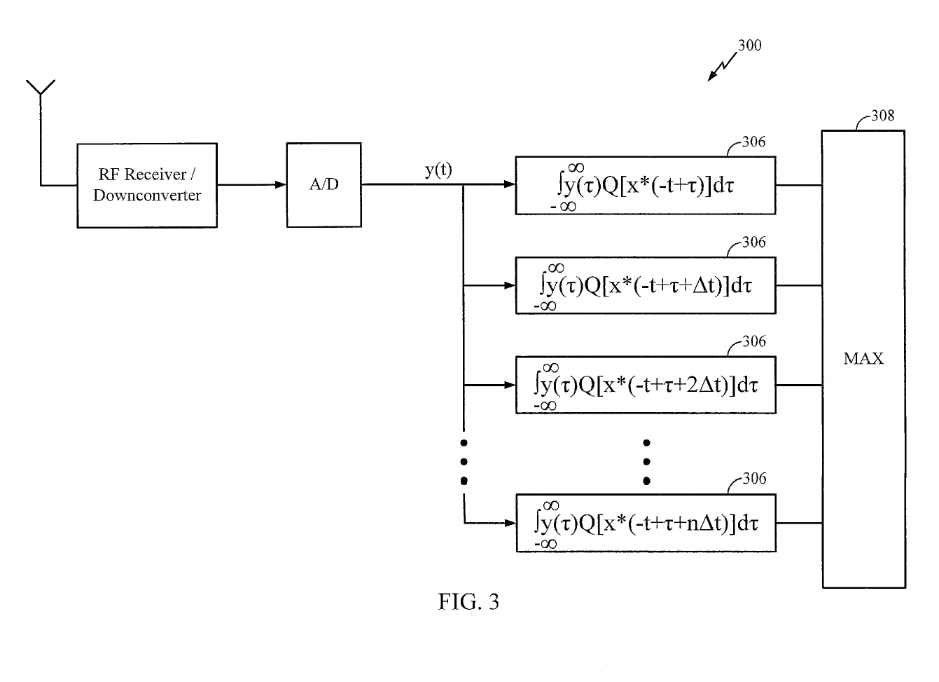

Block 204 may apply a version of the known waveform or data sequence at time-staggered quasi-matched filter correlators to the payload to detect a correlation peak or maximum. The time-staggered quasi matched filter correlators may be implemented as illustrated in FIG. 3 and discussed below. Here a time corresponding to a correlation peak or maximum among output signals of the time-staggered quasi matched filter may indicate a time of arrival of the packets wirelessly received at block 202. Based, at least in part, on a time corresponding to the correlation peak or maximum and a time reference, block 206 may estimate a time of arrival of the one or more received packets. As pointed out above, obtaining accurate estimates of times of arrival of packets transmitted by three different transmitters positioned at known locations may enable a mobile device to compute an estimate of its location using OTDOA techniques.

FIG. 3 is a schematic diagram of a receiver 300 for detecting a time of arrival of a received data packet (e.g., as shown in FIG. 2) according to an embodiment. A radio frequency (RF) receiver/downconverter 302 may downconvert a wirelessly received RF signal to a baseband signal using any one of several techniques. The baseband signal may be sampled at analog to digital converter 304 to produce a digital signal y(t) representing a received data packet. In a particular implementation, signal y(t) may be modeled as a convolution in expression (1) as follows:

y(t)=∫_{-∞}^{∞}x(t−τ)h(τ)dτ+n(t) (1)

where:
x(t) is a transmitted signal;
h(t) represents a communication channel; and
n(t) represents noise.

A matched filter expression for detecting x(t) from y(t) in the presence of noise may comprise a convolution as ∫_{-∞}^{∞}y(t)x*(τ−t)dτ. However, convolving y(t) over the entirety of x(t) may not be necessary for correlation peak detection and may be an inefficient use of processing resources (e.g., battery capacity). In the particular implementation of FIG. 3, time-staggered correlators 306 may apply a quasi-matched filter by convolving a quantized version of x(t) according to expression (2) as follows:

∫_{-∞}^{∞}y(τ)Q[x*(τ−t+Δt)]dτ (2)

where the function Q[x(t)] is a quantizer of x(t).

In a particular implementation, function Q[x(t)] may map continuous values of x(t) to a finite set of discrete values. In one implementation, a one-bit quantizer implementation of function Q[x(t)] may map values of x(t) to −1 and 1. In a two-bit quantizer implementation of Q[x(t)] may map values of x(t) to values −2, −1, 1 and 2. In a particular implementation of a multi-bit quantizer, a gain control may be applied to x(t) to avoid saturation. Of course these are merely example implementations of a quantizer and claimed subject matter is not limited in this respect.

As shown in FIG. 3, correlators 306 are time-staggered in that the signals to be convolved with signal y(t) are set off from one another in increments of Δt. In one implementation, a maximum detector 308 may determine which of multiple time-staggered correlators 306 provides the highest output signal representing a “correlation peak” or “correlation maximum” detected at maximum detector 308. Based, at least in part, on a timing reference, and a time associated with the correlation peak or correlation maximum detected at maximum detector 308 may then correspond with a precise arrival time of a wirelessly received packet represented by y(t). As can be observed, correlators 306 are time-staggered in increments of Δt. In a particular implementation, maximum detector 308 may interpolate a correlation peak or maximum between or among correlation output signals from adjacent correlators 306. Correlators 306 and maximum detector 308 may be implemented using any one or a combination of several structures including, for example, machine-readable instructions stored in a non-transitory memory and executed by a programmable processor, field programmable gate arrays, digital signal processors, ASIC logic, just to provide a few examples.

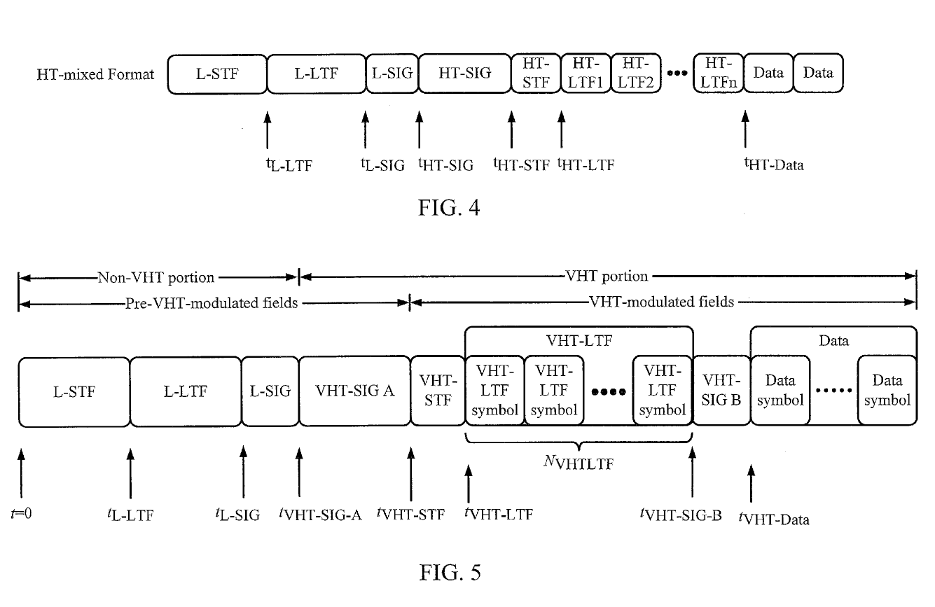

As pointed out above in a particular implementation, correlators 306 may convolve at least a portion of signal y(t) representing a wirelessly received packet with a quantized version of x(t). In a particular implementation where a wirelessly received packet comprises a packet formatted according to IEEE std. 802.11, fields of the received data packet may be parsed from signal y(t) by detection of particular fields. FIGS. 4 and 5 show formats for a data packet formatted according to IEEE std. 802.11n and IEEE std. 802.11ac, respectively. Here, fields of a data packet formatted as shown in either FIG. 4 or FIG. 5 may be parsed based, at least in part, on detection of field L-LTF, to which subsequent fields or symbols in the received data packet may be referenced. A convolution of the subsequent fields or symbols with a quantized version of x(t) at correlators 306 may then be used for detection of accurate timing. In one implementation, the subsequent fields or symbols may comprise copies of field L-LTF. In other implementations, the subsequent fields or symbols may comprise constant amplitude zero autocorrelation sequences or a pseudonoise code as used to modulate signals in a CDMA data channel or GPS signal, just to provide a couple of additional examples. In one particular implementation, a mobile device may transmit one or more request messages to one or more transmitters requesting transmission of one or more packets having a payload comprising the fields or symbols to be convolved with x(t) at correlators 306. In one implementation, correlators 306 may be dynamically configured in a baseband processor following or in response to transmission of the one or more request messages for the one or more packets having the special payload. Here, as the request messages may be addressed to specific transmitters, correlators 306 may be configured in such a baseband processor in anticipation of receipt of packets from the specific transmitters with a special payload for processing.

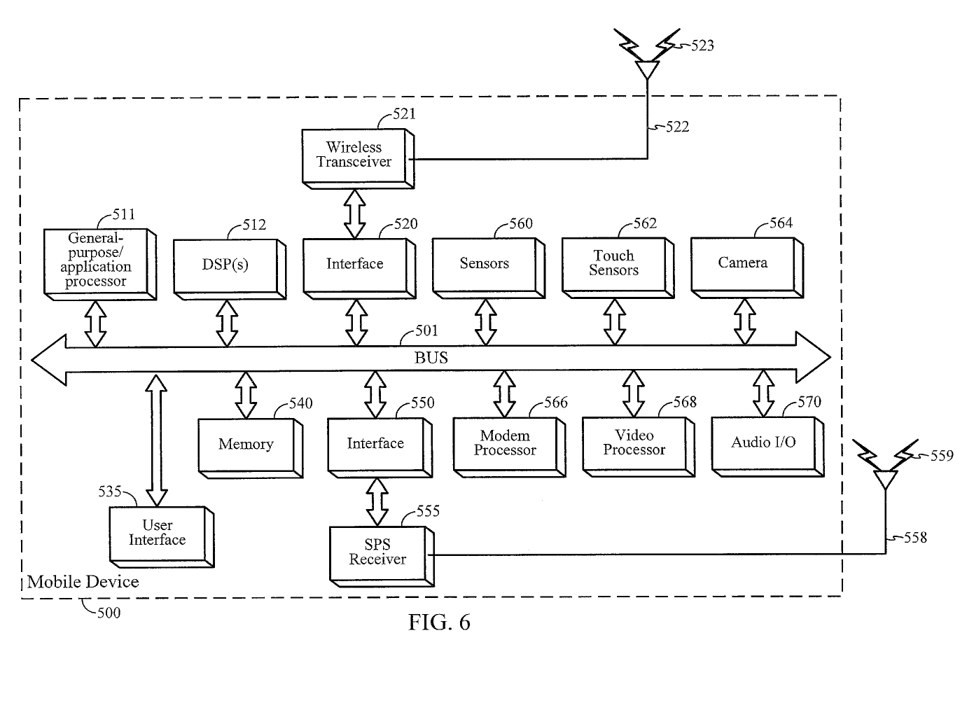

FIG. 6 is a schematic diagram of a mobile device according to an embodiment. Mobile device 100 (FIG. 1) may comprise one or more features of mobile device 500 shown in FIG. 6. In certain embodiments, mobile device 500 may also comprise a wireless transceiver 521 which is capable of transmitting and receiving wireless signals 523 via a wireless antenna 522 over a wireless communication network. Wireless transceiver 521 may be connected to bus 501 by a wireless transceiver bus interface 520. Wireless transceiver bus interface 520 may, in some embodiments be at least partially integrated with wireless transceiver 521. Some embodiments may include multiple wireless transceivers 521 and wireless antennas 522 to enable transmitting and/or receiving signals according to a corresponding multiple wireless communication standards such as, for example, WiFi, CDMA, WCDMA, LTE and Bluetooth, just to name a few examples.

Mobile device 500 may also comprise SPS receiver 555 capable of receiving and acquiring SPS signals 559 via SPS antenna 558. SPS receiver 555 may also process, in whole or in part, acquired SPS signals 559 for estimating a location of mobile device 500. In some embodiments, general-purpose processor(s) 511, memory 540, DSP(s) 512 and/or specialized processors (not shown) may also be utilized to process acquired SPS signals, in whole or in part, and/or calculate an estimated location of mobile device 500, in conjunction with SPS receiver 555. Storage of SPS or other signals for use in performing positioning operations may be performed in memory 540 or registers (not shown).

Also shown in FIG. 6, mobile device 500 may comprise digital signal processor(s) (DSP(s)) 512 connected to the bus 501 by a bus interface 510, general-purpose processor(s) 511 connected to the bus 501 by a bus interface 510 and memory 540. Bus interface 510 may be integrated with the DSP(s) 512, general-purpose processor(s) 511 and memory 540. In various embodiments, functions may be performed in response execution of one or more machine-readable instructions stored in memory 540 such as on a computer-readable storage medium, such as RAM, ROM, FLASH, or disc drive, just to name a few example. The one or more instructions may be executable by general-purpose processor(s) 511, specialized processors, or DSP(s) 512. Memory 540 may comprise a non-transitory processor-readable memory and/or a computer-readable memory that stores software code (programming code, instructions, etc.) that are executable by processor(s) 511 and/or DSP(s) 512 to perform functions described herein.

Also shown in FIG. 6, a user interface 535 may comprise any one of several devices such as, for example, a speaker, microphone, display device, vibration device, keyboard, touch screen, just to name a few examples. In a particular implementation, user interface 535 may enable a user to interact with one or more applications hosted on mobile device 500. For example, devices of user interface 535 may store analog or digital signals on memory 240 to be further processed by DSP(s) 512 or general purpose processor/application processor 511 in response to action from a user. Similarly, applications hosted on mobile device 500 may store analog or digital signals on memory 540 to present an output signal to a user. In another implementation, mobile device 500 may optionally include a dedicated audio input/output (I/O) device 570 comprising, for example, a dedicated speaker, microphone, digital to analog circuitry, analog to digital circuitry, amplifiers and/or gain control. It should be understood, however, that this is merely an example of how an audio I/O may be implemented in a mobile device, and that claimed subject matter is not limited in this respect. In another implementation, mobile device 500 may comprise touch sensors 562 responsive to touching or pressure on a keyboard or touch screen device.

Mobile device 500 may also comprise a dedicated camera device 564 for capturing still or moving imagery. Camera device 564 may comprise, for example an imaging sensor (e.g., charge coupled device or CMOS imager), lens, analog to digital circuitry, frame buffers, just to name a few examples. In one implementation, additional processing, conditioning, encoding or compression of signals representing captured images may be performed at general purpose/application processor 511 or DSP(s) 512. Alternatively, a dedicated video processor 568 may perform conditioning, encoding, compression or manipulation of signals representing captured images. Additionally, video processor 568 may decode/decompress stored image data for presentation on a display device (not shown) on mobile device 500.

Mobile device 500 may also comprise sensors 560 coupled to bus 501 which may include, for example, inertial sensors and environment sensors. Inertial sensors of sensors 560 may comprise, for example accelerometers (e.g., collectively responding to acceleration of mobile device 500 in three dimensions), one or more gyroscopes or one or more magnetometers (e.g., to support one or more compass applications). Environment sensors of mobile device 500 may comprise, for example, temperature sensors, barometric pressure sensors, ambient light sensors, camera imagers, microphones, just to name few examples. Sensors 560 may generate analog or digital signals that may be stored in memory 540 and processed by DPS(s) or general purpose processor/application processor 511 in support of one or more applications such as, for example, applications directed to positioning or navigation operations.

In a particular implementation, mobile device 500 may comprise a dedicated modem processor 566 capable of performing baseband processing of signals received and downconverted at wireless transceiver 521 or SPS receiver 555. Similarly, modem processor 566 may perform baseband processing of signals to be upconverted for transmission by wireless transceiver 521. In alternative implementations, instead of having a dedicated modem processor, baseband processing may be performed by a general purpose processor or DSP (e.g., general purpose/application processor 511 or DSP(s) 512). It should be understood, however, that these are merely examples of structures that may perform baseband processing, and that claimed subject matter is not limited in this respect. In particular applications, mobile device 500 may be capable of performing some or all of actions at blocks 202, 204 and 206 described above with reference to FIG. 2.

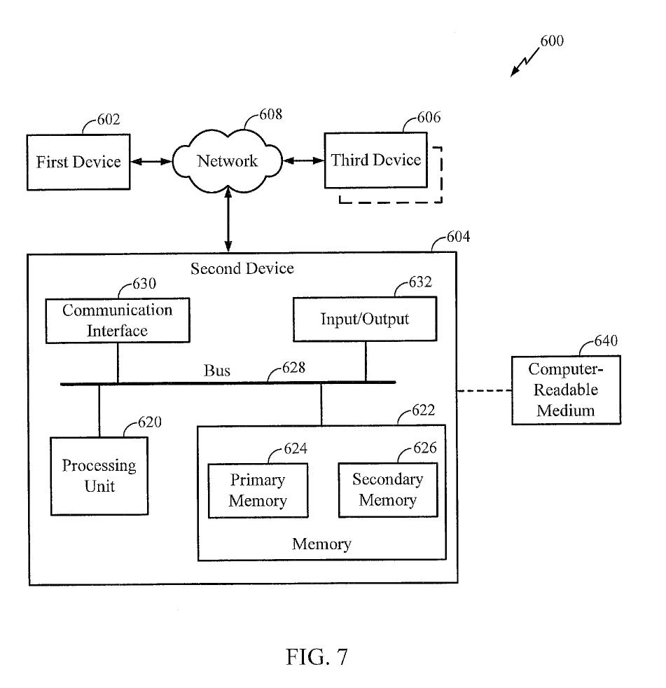

FIG. 7 is a schematic diagram illustrating an example system 600 that may include one or more devices configurable to implement techniques or processes described above, for example, in connection with FIG. 1. System 600 may include, for example, a first device 602, a second device 604, and a third device 606, which may be operatively coupled together through a wireless communications network 608. In an aspect, first device 602 may comprise a server capable of providing positioning assistance data such as, for example, a base station almanac. Second and third devices 604 and 606 may comprise mobile devices, in an aspect. Also, in an aspect, wireless communications network 608 may comprise one or more wireless access points, for example. However, claimed subject matter is not limited in scope in these respects.

First device 602, second device 604 and third device 606, as shown in FIG. 6, may be representative of any device, appliance or machine that may be configurable to exchange data over wireless communications network 608. By way of example but not limitation, any of first device 602, second device 604, or third device 606 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or data storage service provider/system, a network service provider/system, an Internet or intranet service provider/system, a portal or search engine service provider/system, a wireless communication service provider/system; or any combination thereof. Any of the first, second, and third devices 602, 604, and 606, respectively, may comprise one or more of a base station almanac server, a base station, or a mobile device in accordance with the examples described herein.

Similarly, wireless communications network 608, as shown in FIG. 6, is representative of one or more communication links, processes, or resources configurable to support the exchange of data between at least two of first device 602, second device 604, and third device 606. By way of example but not limitation, wireless communications network 608 may include wireless or wired communication links, telephone or telecommunications systems, data buses or channels, optical fibers, terrestrial or space vehicle resources, local area networks, wide area networks, intranets, the Internet, routers or switches, and the like, or any combination thereof. As illustrated, for example, by the dashed lined box illustrated as being partially obscured of third device 606, there may be additional like devices operatively coupled to wireless communications network 608.

It is recognized that all or part of the various devices and networks shown in system 600, and the processes and methods as further described herein, may be implemented using or otherwise including hardware, firmware, software, or any combination thereof.

Thus, by way of example but not limitation, second device 604 may include at least one processing unit 620 that is operatively coupled to a memory 622 through a bus 628.

Processing unit 620 is representative of one or more circuits configurable to perform at least a portion of a data computing procedure or process. By way of example but not limitation, processing unit 620 may include one or more processors, controllers, microprocessors, microcontrollers, application specific integrated circuits, digital signal processors, programmable logic devices, field programmable gate arrays, and the like, or any combination thereof.

Memory 622 is representative of any data storage mechanism. Memory 622 may include, for example, a primary memory 624 or a secondary memory 626. Primary memory 624 may include, for example, a random access memory, read only memory, etc. While illustrated in this example as being separate from processing unit 620, it should be understood that all or part of primary memory 624 may be provided within or otherwise co-located/coupled with processing unit 620.

Secondary memory 626 may include, for example, the same or similar type of memory as primary memory or one or more data storage devices or systems, such as, for example, a disk drive, an optical disc drive, a tape drive, a solid state memory drive, etc. In certain implementations, secondary memory 626 may be operatively receptive of, or otherwise configurable to couple to, a computer-readable medium 640. Computer-readable medium 640 may include, for example, any non-transitory medium that can carry or make accessible data, code or instructions for one or more of the devices in system 600. Computer-readable medium 640 may also be referred to as a storage medium.

Second device 604 may include, for example, a communication interface 630 that provides for or otherwise supports the operative coupling of second device 604 to at least wireless communications network 608. By way of example but not limitation, communication interface 630 may include a network interface device or card, a modem, a router, a switch, a transceiver, and the like.

Second device 604 may include, for example, an input/output device 632. Input/output device 632 is representative of one or more devices or features that may be configurable to accept or otherwise introduce human or machine inputs, or one or more devices or features that may be configurable to deliver or otherwise provide for human or machine outputs. By way of example but not limitation, input/output device 632 may include an operatively configured display, speaker, keyboard, mouse, trackball, touch screen, data port, etc.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femto cell, utilized to extend cellular telephone service into a business or home. In such an implementation, one or more mobile devices may communicate with a femto cell via a code division multiple access (“CDMA”) cellular communication protocol, for example, and the femto cell may provide the mobile device access to a larger cellular telecommunication network by way of another broadband network such as the Internet.

Techniques described herein may be used with an SPS that includes any one of several GNSS and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

What is claimed is:

1. A method comprising, at a mobile device:
wirelessly receiving one or more packets from a transmitter transmitted according to an IEEE std. 802.11 waveform, a payload of at least one of said received packets comprising a known waveform or data sequence; and
applying said known waveform or data sequence at time-staggered quasi-matched filter correlators to said payload to detect a correlation peak; and
estimating a time of arrival of said at least one of said received packets based, at least in part, on said correlation peak and a time reference.

2. The method of claim 1, and further comprising:
receiving at least one of said packets transmitted according to the IEEE std. 802.11 waveform from each of three or more transmitters positioned at known locations;
measuring differences in times of arrival of said packets received from each of said three or more transmitters; and
estimating a location of said mobile device based, at least in part, on the measured differences.

3. The method of claim 1, and further comprising:
transmitting one or more request messages to the transmitter requesting the at least one of said received packets having the payload comprising the known waveform or data sequence; and
configuring a baseband processor to apply said time-staggered quasi-matched filter correlators.

4. The method of claim 1, wherein said known waveform or data sequence comprises a repeated field in the at least one said received packets.

5. The method of claim 1, wherein the known waveform or data sequence comprises a pseudonoise code.

6. The method of claim 1, wherein the time-staggered quasi-matched filter correlators are configured to convolve a quantized version of the known waveform or data sequence with at least a portion of the payload.

7. The method of claim 6, wherein the quantized version of the known waveform or data sequence is less than an entirety of the known waveform or data sequence.

8. The method of claim 6, wherein said quantized version of the known waveform or data sequence comprises a mapping of the known waveform or data sequence to a finite set of discrete values.

9. The method of claim 6, wherein said quantized version of the known waveform or data sequence comprises a mapping of the known waveform or data sequence to a finite set of two discrete values.

10. The method of claim 6, wherein said quantized version of the known waveform or data sequence comprises a mapping of the known waveform or data sequence to a finite set of four discrete values.

11. A mobile device comprising:
a receiver to receive one or more signals from a wireless network;
a plurality of time-staggered quasi-matched filter correlators configurable to convolve at least a portion of one or more packets received at said receiver and transmitted according to an IEEE std. 802.11 waveform, a payload of at least one of said received packets comprising a known waveform or data sequence; and
one or more processors to:
determine a correlation peak output signal among said time-staggered quasi-matched filter correlators; and
estimate a time of arrival of said at least one of said received packets based, at least in part, on said correlation peak output signal and a time reference.

12. The mobile device of claim 11, wherein said one or more processors are further to:
measure differences in times of arrival of packets received at said receiver and transmitted according to the IEEE std. 802.11 waveform from each of three or more transmitters positioned at known locations; and
estimate a location of said mobile device based, at least in part, on the measured differences.

13. The mobile device of claim 11, wherein said one or more processors are further to:
initiate transmission of one or more request messages to a transmitter requesting the at least one of said received packets having the payload comprising the known waveform or data sequence.

14. The mobile device of claim 11, wherein said known waveform or data sequence comprises a repeated field in the at least one of said received packets.

15. The mobile device of claim 11, wherein the known waveform or data sequence comprises a pseudonoise code.

16. The mobile device of claim 11, wherein the time-staggered quasi-matched filter correlators are configured to convolve a quantized version of the known waveform or data sequence with at least a portion of the payload.

17. The mobile device of claim 16, wherein the quantized version of the known waveform or data sequence is less than an entirety of the known waveform or data sequence.

18. The mobile device of claim 16, wherein said quantized version of the known waveform or data sequence comprises a mapping of the known waveform or data sequence to a finite set of discrete values.

19. The mobile device of claim 16, wherein said quantized version of the known waveform or data sequence comprises a mapping of the known waveform or data sequence to a finite set of two discrete values.

20. The mobile device of claim 16, wherein said quantized version of the known waveform or data sequence comprises a mapping of the known waveform or data sequence to a finite set of four discrete values.

21. An article comprising:
a non-transitory storage medium comprising machine-readable instructions stored thereon which are executable by a special purpose computing apparatus to:
obtain a payload portion of at least one packet wirelessly received from a transmitter transmitted according to an IEEE std. 802.11 waveform, the payload portion comprising a known waveform or data sequence;
apply said known waveform or data sequence at time-staggered quasi-matched filter correlators to said payload portion to detect a correlation peak; and
estimate a time of arrival of said at least one packet based, at least in part, on said correlation peak and a time reference.

22. The article of claim 21, wherein said instructions are further executable by said special purpose computing apparatus to:
initiate transmission of one or more request messages to the transmitter requesting the at least one said received packets having a payload comprising the known waveform or data sequence.

23. The article of claim 21, wherein said known waveform or data sequence comprises a repeated field in the at least one of said received packets.

24. The article of claim 21, wherein the known waveform or data sequence comprises a pseudonoise code.

25. The article of claim 21, wherein the time-staggered quasi-matched filter correlators are configured to convolve a quantized version of the known waveform or data sequence with at least a portion of the payload portion.

26. The article of claim 25, wherein the quantized version of the known waveform or data sequence is less than an entirety of the known waveform or data sequence.

27. The article of claim 25, wherein said quantized version of the known waveform or data sequence comprises a mapping of the known waveform or data sequence to a finite set of discrete values.

28. The article of claim 25, wherein said quantized version of the known waveform or data sequence comprises a mapping of the known waveform or data sequence to a finite set of two discrete values.

29. The article of claim 25, wherein said quantized version of the known waveform or data sequence comprises a mapping of the known waveform or data sequence to a finite set of four discrete values.

30. An apparatus comprising:
means for wirelessly receiving one or more packets from a transmitter transmitted according to an IEEE 802.11 waveform, a payload of at least one of said received packets comprising a known waveform or data sequence; and
means for applying said known waveform or data sequence at time-staggered quasi-matched filter correlators to said payload to detect a correlation peak; and
means for estimating a time of arrival of said at least one of said at least one of said received packets based, at least in part, on said correlation peak and a time reference.
